(19) United States
(12) Patent Application Publication
(10) Pub. No.: US 2011/0011700 A1
(43) Pub. Date: Jan. 20, 2011

(54) DEVICE AND METHOD FOR MONITORING AN ESCALATOR OR MOVING WALKWAY

(75) Inventors: Antti PLATHIN, Hyvinkaa (FI); Dirk LANGE, Dortmund (DE)

Correspondence Address: VENABLE LLP, P.O. BOX 34385, WASHINGTON, DC, 20043-9998, US

(73) Assignee: KONE Corporation, Helsinki (FI)

(21) Appl. No.: 12/856,846

(22) Filed: Aug. 16, 2010

Related U.S. Application Data
(63) Continuation of application No. PCT/EP2009/051658, filed on Feb. 12, 2009.

(30) Foreign Application Priority Data
Feb. 15, 2008 (DE) 102008009458.7

(51) Int. Cl. B66B 29/00

(52) U.S. Cl. 198/323

(57) ABSTRACT

In an escalator or travelator configured to travel in two directions and including a step or pallet belt returned in first and second return portions facing away from each other, a monitoring device and method for detecting steps or pallets of the step or pallet belt is provided. The device includes a first detector configured to detect the steps or pallets in one of the directions of travel, a second detector configured to detect the steps or pallets in the other direction of travel, and an electronic analyzer/controller functionally coupled with each of the first and second detectors. The electronic analyzer/controller is configured to receive and compare signals from the first and second detectors for the two directions of travel and derive therefrom a signal for halting the escalator or travelator. When the signals from at least one of the first and second detectors indicates a missing step or pallet within the step or pallet belt, the electronic analyzer/controller outputs the derived signal to halt a drive of the escalator or travelator.

### CROSS-REFERENCE TO RELATED APPLICATION

This application is a continuation application of International PCT Application No. PCT/EP2009/051658, filed Feb. 12, 2009, designating the United States and claiming priority of German Patent Application No. DE 102008009458.7, filed Feb. 15, 2008, the disclosure of both applications being incorporated by reference herein in their entireties.

### BACKGROUND OF THE INVENTION

1. Field of Invention

The invention relates to an escalator or travelator comprising a step or pallet monitoring device.

2. Related Art

Escalators and travelators must be equipped to meet existing safety codes in a number of countries around the world such that they automatically halt as soon as problems occur in some critical area.

European patent document EP 1 289 871 discloses a device using a redundant method to safeguard the function of one or more detectors for detecting missing steps. The hardware needed for this purpose is relatively complicated, especially when the system needs to be operated in both directions of travel.

### SUMMARY

It is an object of the invention to provide, in an escalator or travelator constructed for two directions of travel, a monitoring device for detecting missing steps or pallets of a step or pallet belt in both directions of travel.

According to an embodiment of the invention, in an escalator or travelator configured to travel in two directions and comprising a step or pallet belt returned in first and second return portions facing away from each other, a monitoring device for detecting steps or pallets of the step or pallet belt is provided. The device includes a first detector configured to detect the steps or pallets in one of the directions of travel, a second detector configured to detect the steps or pallets in the other direction of travel, and an electronic analyzer/controller functionally coupled with each of the first and second detectors. The electronic analyzer/controller is configured to receive and compare signals from the first and second detectors for the two directions of travel and derive therefrom a signal for halting the escalator or travelator. When the signals from at least one of the first and second detectors indicates a missing step or pallet within the step or pallet belt, the electronic analyzer/controller outputs the derived signal to halt a drive of the escalator or travelator.

According to another embodiment, in an escalator or travelator configured to travel in two directions and having a step or pallet belt returned in first and second return portions facing away from each other, a method for monitoring the presence of steps or pallets of the step or pallet belt with a monitoring device is provided. The monitoring device has a first detector configured to detect the steps or pallets in one of the directions of travel, a second detector configured to detect the steps or pallets in the other direction of travel, and an electronic analyzer/controller functionally coupled with each of the first and second detectors. The method includes receiving signals from the first and second detectors corresponding to the steps or pallets, comparing the signals from the first and second detectors, and outputting a signal to a drive of the escalator or travelator to halt the escalator or travelator when the comparison indicates a missing step or pallet within the step or pallet belt.

According to another embodiment of the invention, signals of two detectors are compared in which the spacing of the first detector from the first return portion or from the first comb plate is less than the spacing from the second return portion or second comb plate, and the spacing of the second detector from the second return portion or second comb plate is less than the spacing from the first return portion or first comb plate. Several first and second detectors may be used for diverse monitoring functions as is detailed in the following description.

This has the advantage that monitoring a checking function redundantly is crossed with the redundant monitoring in both directions of travel. The detector signals are compared to each other of detectors provided roughly in the same position or closely spaced from each other in producing roughly the same signal sequence. For example, the signals of the detectors are now arranged as a rule more in a defined spacing from the opposite ends of the comb plates of the escalator to realize the same checking function for both different directions of travel. The signals of these detectors, although identical in their pulse configuration, are phase-shifted.

Despite them being phase-shifted, comparing these signals in signal processing is no problem. By simply comparing the signals, it can now be instantly detected when there is a change in how the two signal sequences relate to each other, be it due to a step or pallet being missing, due to a wiring break, or due to malfunction of a detector or in signal processing, e.g. of a microprocessor.

According to an embodiment of the invention, it may be possible to provide a redundant monitoring of the detector signals (detecting a faulty or missing step) for both directions of travel with just a total of two detectors and, where necessary, two signal processors, e.g. microprocessors. This makes for enormous savings in the hardware required because the detectors now no longer need to be provided double for each function and each direction of travel.

According to another embodiment, providing several detectors for one direction of travel can now be used for a variety of functions, such as, e.g., detecting a missing step or pallet in the return portion to avoid it entering the exposed run, detecting diverse zones of the steps or pallets (e.g., axle and steps or pallet bodies/surface), and detecting missing steps or pallets in the exposed run to prevent them entering the comb plate.

To realize these functions, it is necessary that the detectors are arranged at a defined minimum spacing from the comb plate or from the return portion. The typical halting travel of the escalator/travelator, depending on the load and size, ranges from 30 cm to 1.5 m. The spacing is to be selected so that this run-on of the escalator is assured before the missing step leaves from under the comb plate or enters the comb plate from above. This is why a spacing ranging from 50 cm to 3 m from the comb plate or return portion would be an advantage.

But, appropriate in this context is to precisely arrange the two detectors for mutual monitoring of the identical task in each direction of travel.

For this purpose, the signals of the detectors may be compared to each other either in a main (central) controller or in the two microprocessors, for example, after processing by the latter. This comparison may be done, for example, by forming the difference or sum of both signals, for instance by way of digital signal processing. Differences in the signal pattern of the two detectors from the comparison or after processing by the microprocessors are instantly detected. For example, if a missing step is detected, or if a detector, the wiring, or a microprocessor become defective, each of these events is instantly detected as a change in the ratio of the two comparison patterns each relative to the other, resulting in a signal being supplied to the main controller of the escalator/travelator to instantly halt and/or decelerate the escalator/travelator.

In an embodiment, the device may be utilized in an escalator, it being understood, however, that the invention relates to all steps, plates or other supporting elements following each in sequence in the longitudinal direction of conveyance as are combined into a transport element forming an endless loop, such as, for example, travelators.

In an embodiment, the spacing of the first detector from the first return portion or from the first comb plate is less than from the second return portion or second comb plate and the spacing of the second detector from the second return portion or from the second comb plate is less than from the first return portion or from the first comb plate.

To ensure proper functioning of the redundancy check, the signals of both detectors should always be compared irrespective of the direction of travel of the escalator/travelator, i.e. the detectors should always be operated and evaluated simultaneously.

In yet another embodiment, each first and second detector is equally spaced away from its corresponding nearer return portion or nearer comb plate to ensure symmetrical function detection (missing step upper or lower or at diverse positions of the step/pallet) in both directions of travel.

To avoid entry of a missing step into a comb plate, first and second upper detectors may be arranged in the region of the exposed upper run of the escalator/travelator.

To avoid entry of a missing step into the exposed portion, first and second lower detectors may be arranged in the region of the return run of the escalator/travelator.

In an embodiment, the electronic analyzer/controller may include a first microprocessor coupled to the first detector and a second microprocessor coupled to the second detector, the first and second microprocessors each working independent of the other as mutual monitoring devices. In this way, the detection function (e.g, of the missing step/pallet), monitoring detection, wiring and signal processing can be checked simultaneously redundantly.

In this context, for a fast response, the microprocessors may be wired to safety contacts to instantly halt the escalator or travelator.

In an embodiment, the first and second detectors include proximity or contactless detectors to enhance reliability and facilitate maintenance.

In yet another embodiment, several first and second detectors are arranged or mounted at various levels at the escalator to monitor diverse portions of the step or pallet.

For example, for reliable detection without influencing the escalator, the detector(s) is/are directed at the pins of the step or pallet pulley provided outside of each drive train.

In an embodiment, the microprocessors exchange status messages with one another within pre-programmable time intervals. The status messages include the operating condition of each of the detectors as well as the status of the respective microprocessor.

According to an embodiment, the device provides proximal or contactless detection of missing steps or pallets by monitoring characteristic and continually reoccurring features existing on each step or pallet.

For example, to avoid added complexity, the axle of each step or pallet can be used as the characterizing feature, usually in cooperation with a belt pulley rolling over a guide, and thus always arranged at the same level.

The detector(s) is/are positioned by an assigned support in the region of the frame and directed at the characterizing feature such as, for example, the pin of the step or pallet rollers provided outside of the drive train.

According to an embodiment, the mutual monitoring processors now make it possible to provide a redundant analysis, whereby failure of a processor prompts the still active processor to generate a corresponding alarm to activate repair and halt the escalator or travelator when required.

By providing redundancy in detection, and thus a further enhancement of the safety, the device may satisfy even the most stringent regulations of some countries.

Should a detector become defective, or matching the mutual monitoring processors fail to be identical, the escalator or travelator is automatically halted.

In still another embodiment, within the analyzer/controller electronics, the speed profiles (normal travel, creep travel) required of the escalator/travelator are stored so that the timing in passing by the detector(s) materializing from the changes in speed is reliably “seen” by the analyzer/controller electronics and assigned to the operating condition concerned. To adjust to the various speeds smart software such as adaptive speed sensing, auto tuning and teach-in methods can be put to use.

During maintenance work on the escalator/travelator, manual inspection operation of the step/pallet belt needs to be provided by means of special switching elements to permit overriding the safety device for this purpose.

In an embodiment, wireless communication of the detector signals to the analyzer/controller electronics is provided by known radio, ultrasonic or infrared means, for which purpose both the detectors and the controller electronics are equipped with a corresponding wireless transceiver. The advantage of this is that it avoids wiring problems as may very easily occur when the detectors are wired far away from the opposite ends of the escalator. In addition to this, positioning both the detectors and the analyzer/controller electronics can be freely selected when the detectors, for example all detectors, have wireless communication with the analyzer/controller electronics. In this context, the analyzer/controller electronics can be housed to great advantage together with the main controller of the escalator/travelator in a main control cabinet, for instance, offering better access to the controller components as well as a space-saving accommodation of the various controller components.

In an embodiment, the detector signals can also be communicated to at least one device monitoring the status or activity of the detectors in thus enhancing safe operation of the escalator/travelator.

In addition to this, the signals of the components can be forwarded by very simple means to various electronic components in the escalator such as, for example, the various microprocessors and/or additional components of a safety circuit of the escalator and/or its main controller without any additional wiring being involved.

According to an embodiment, for wireless communication, the detectors are connected to transmitters or transceivers and the analyzer/controller electronics are likewise connected to a transceiver or transmitter for data exchange with all components. For example, each microprocessor of the analyzer/controller electronics may be connected to its own receivers or transceivers, enhancing redundancy and thus safe operation of the device. The analyzer/controller electronics may also comprise a wireless transmitter and/or transceiver communicating with the various components of the escalator and/or a central controller of group of escalators or transport controller of the building.

According to yet another embodiment, other units with which the detectors and/or the analyzer/controller electronics can communicate are, e.g., safety-relevant detectors or contacts of the passenger conveyor and/or a main controller of the escalator and/or a controller for all passenger handling means in the building such as e.g. escalators, travelators and elevators. Here, the communication between the units is handled in addition, or alternatively, by a serial data bus and is capable of communicating status information of the analyzer/controller electronics and/or safety switches.

In this embodiment, the wireless communication of any safety device of the passenger conveyor system (escalator, travelator or elevator) with other electronic components of the passenger conveyor system, particularly controller components, may be provided. The advantages attained may include enhanced safe operation, reduced wiring complexity and more freedom in positioning the units as compared to prior art. In conjunction with the example embodiment as described, the wireless communication of the safety-relevant analyzer/controller electronics with other units such as, e.g., corresponding safety components and detectors as well as the escalator main controller may be provided.

In an embodiment, such a passenger conveyor system could be defined as follows: A passenger conveyor system such as, for example, an escalator or travelator, comprising at least two components each separate from the other and connected to a device for wireless signal communication and via which said devices can exchange data. Detectors in such as system may be arranged along the conveyor path, each of which is connected to a first transceiver device for wireless signal communication. Control and/or monitoring electronics may be connected to a second transceiver device communicating with the first transceiver devices of the detectors. The first transceiver devices may be integrated in the detectors. The second transceiver device may be integrated in the controller electronics.

All that is needed in principle is that the detectors be connected to transmitter devices and the controller electronics to a receiver device. However, in an embodiment, when the detectors and the controller electronics of the passenger conveyor system are sophisticated with means for bidirectional data communication, test signals can also be output to the detectors to check out the sensors and/or electronics of the detector by the controller electronics.

In accordance with a further aspect of the invention, components of the passenger conveyor system generating and/or receiving data can be sophisticated with means for mutual wireless signal communication such as, e.g., a main controller and sub-group controllers of the passenger conveyor system, main and/or sub-group controllers of diverse passenger group conveyor systems of a group thereof such as, e.g., escalators, travelators and elevators in a building or interorganizational area, e.g., a shopping mall or airport.

With reference to the embodiment described below and illustrated in the accompanying drawings, the components connected to separate and/or interconnected means for wireless signal communication may be one or more of the following components:
the analyzer/controller electronics 11 of the tread step monitoring device
the individual microprocessors 16, 17, 36, 37 of the analyzer/controller electronics 11
the detectors 7, 7′,7″,7′″ of the tread step sensing device
other safety-relevant detectors of an escalator, such as, e.g., motor sensing detectors or optical passenger sensing detectors, brake test sensors, handrail speed sensors.
means for monitoring the status of the safety contacts of the escalator as well as the contacts of the safety circuit, e.g. landing plate sensors, handrail entry sensors, emergency OFF switches, etc.

In still another embodiment, the various sensors may be inductive or capacitive-type proximity sensors. They may also work electromagnetically, e.g. as light, ultrasound, infrared, RF sensors, preferably in accordance with the reflective principle, but which may also be used as a kind of light curtain.

According to an embodiment, the detectors may be devised and/or arranged so that they can “see” whether a step/pallet is, for example, missing, maloriented, broken, corroded, soiled, and/or damaged. The detectors may be capable of implementing one or more (e.g., all) of these sensings simultaneously. The aforementioned malfunctions may be sensed by each detector simultaneously when the detector is directed so that it “sees” the parts of the step whose occurrence as defined in time and space reliably excludes a malfunction in the above sense. Thus, a, for instance, maloriented, damaged, corroded or broken step would reflect light differently than a step which is intact and/or properly oriented. The signal time profile can be reliably analyzed by taking into account the speed of the escalator. In another embodiment, the detectors may detect missing/maloriented/damaged parts of a corresponding positioned step/tread plate, e.g. trim panels.

In still another embodiment, at least one, for example two, handrail speed detectors may be provided in signal communication with the analyzer/controller electronics such as, e.g., by bus or wireless communication. In the same way at least one, for example two, motor speed detectors may be provided. The output of these detectors is in signal communication with the analyzer/controller electronics. This is how safe operation of the escalator as a function of the detectors for sensing handrail speed, motor speed and tread step monitoring can be enhanced, which because of the added sensor analysis complexity hitherto could not be integrated in safety chains formed as a rule by simple ON/OFF switches (e.g. door latch detectors).

The analyzer/controller electronics may include all functions involved in sensing, analyzing and open/closed circuit control of the escalator or individual components thereof.

### BRIEF DESCRIPTION OF THE DRAWINGS

The subject matter of the invention will now be detailed by way of an example embodiment with reference to the drawings in which:

FIG. 1 is a diagrammatic illustration of an escalator indicating the safety (monitoring) device with detectors for sensing missing steps according to an embodiment of the invention;

FIG. 2 is a detail view of the safety device of FIG. 1; and

FIG. 3 is a schematic, partial block diagram of the analyzer/controller electronics as used on the escalator shown in FIG. 1 and FIG. 2 in connection with the detectors.

### DETAILED DESCRIPTION

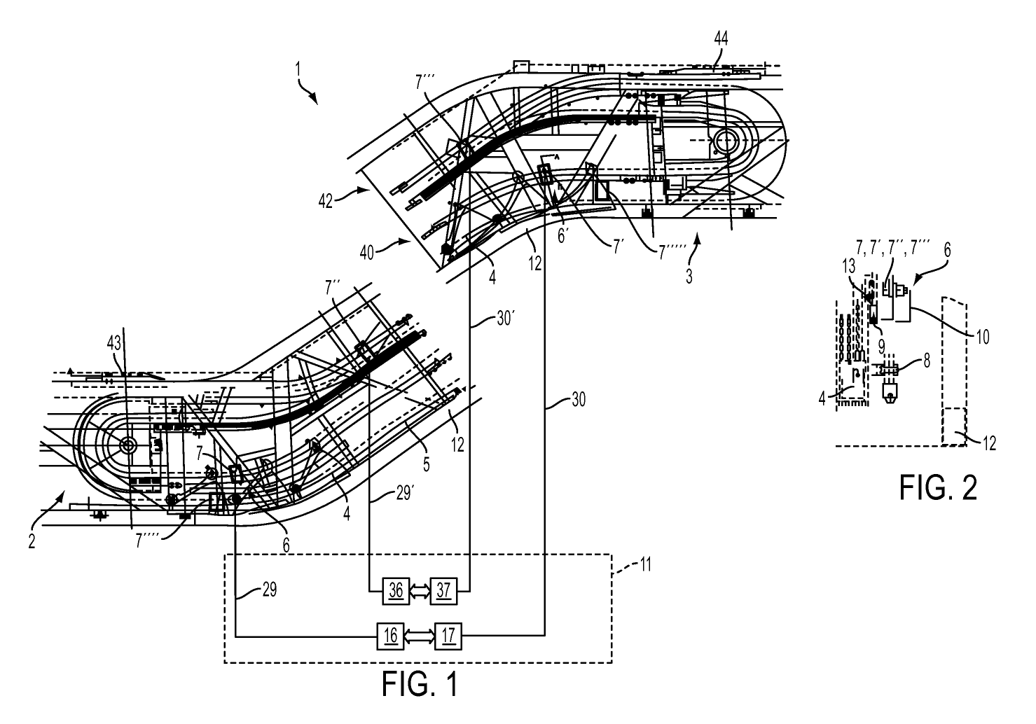

Referring now to the embodiment depicted in FIG. 1, there is illustrated an escalator 1 comprising two return portions 2, 3 for the steps 4 of the step belt 5. Arranged in the vicinity of the first return portion 2, and at a defined spacing away from the first comb plate 43, is a first detector 7. Likewise, in the vicinity of the second return portion 3, and at a defined spacing away from the second comb plate 44, is a second detector 7′. In this arrangement, the two detectors 7, 7′ are located as lower detectors in the return run 40, i.e. in the non-exposed portion of the escalator 1, so that no defect or missing step appears in the exposed portion. In the same way, in addition to or instead of the lower first and second detectors 7, 7′, upper first and second detectors 7″, 7′″ may be provided in the upper run 42, i.e. in the exposed portion of the escalator 1, to prevent a defective step from entering the exposed portion in the region of a comb plate 43, 44 where it could result in injuries or blocked motion.

This is why the first and second detectors 7, 7′, 7″, 7′″ are arranged spaced away from the return portions 2, 3 or from the comb plates 43, 44 to make it possible to decelerate the escalator 1 by reasonable criteria without a defective step 4 appearing in the exposed portion or in the comb plate 43, 44 in the exposed portion. The lower, first and second detectors 7, 7′ are coupled to microprocessors 16, 17, respectively, which mutually check the signals of the two lower detectors 7, 7′ as well as proper functioning of the processors 16, 17 redundantly. In the same way, the upper first and second detectors 7″, 7′″ are coupled to microprocessors 36, 37, respectively, which mutually check the signals of the two upper detectors 7, 7′, 7″, 7′″ as well as proper functioning of each of the other processors 36, 37 redundantly.

In the embodiment depicted in FIG. 1, detectors 7, 7′, 7″, 7′″ are mounted in supports 6 secured to the frame 12 (see FIG. 2) of the escalator 1. Additional first and second detectors 7″″, 7′″″ are provided at another level which are directed at another part of the step or pallet 4 to “see” any faults or fractures in the part of the step or pallet 4 further upwards, whilst the lower first and second detectors 7, 7′ sense, e.g., the step/pallet axle, thus making it possible to detect a partial defect of the step or pallet 4 also in a portion located further upwards. Like the lower and upper first and second detectors 7, 7′, 7″, 7′″, each of the additional first and second detectors 7″″, 7′″″ is coupled to a respective microprocessor (not shown) to mutually check the signals of the two additional detectors 7″″, 7′″″ as well as proper functioning of the other processor redundantly.

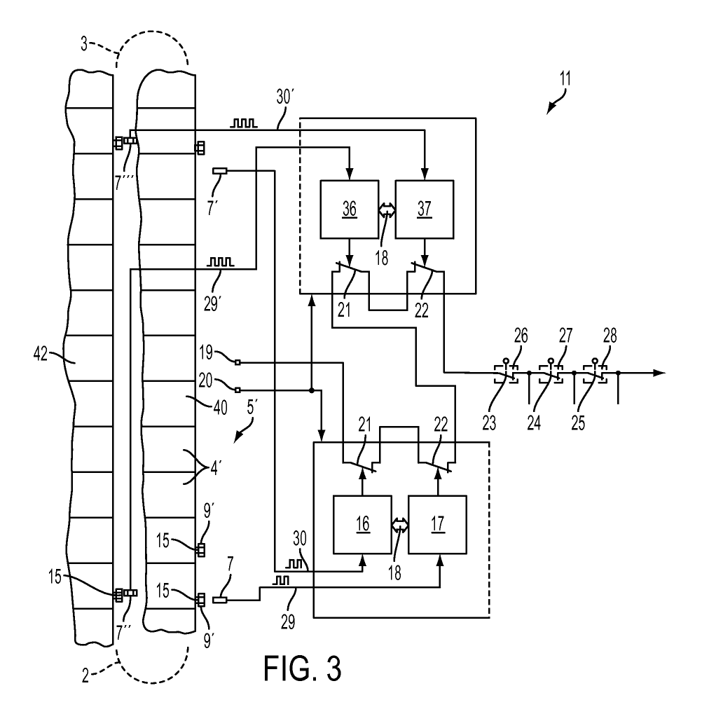

Referring now to the embodiment depicted in FIG. 2, there is illustrated in detail the optional support 6, as evident from FIG. 1, showing a step 4, a drive member 8 hinged to the step 4 as well as a step pulley 9. The lower and upper first and second detectors 7, 7′, 7″, 7′″ are mounted on the support 6 and communicate via a signal lead (see, e.g., signal leads 29, 30, 29′, 30′ in FIGS. 1 and 3) with analyzer/controller electronics 11. The support 6 is secured in the region of the frame 12. The step pulley 9 rolling along a guideway 13 has always the same spacing for each step 4 to thus make it possible with no problem to direct the lower first and second detectors 7, 7′ at the pin 15 (not shown in FIG. 2, but see FIG. 3) of the step pulley 9, resulting in it representing a characteristic, consistently repetitive feature of each step 4.

Referring now to the embodiment depicted in FIG. 3, there is illustrated principally a detail of the analyzer/controller electronics 11 as used on the escalator/travelator 1 as shown in FIGS. 1 and 2 in active communication with the first and second lower detectors 7, 7′ positioned at a definable spacing away from the return portions 2, 3 of the escalator/travelator 1 or from the comb plate 43, 44 (see FIG. 1) at return portions 2, 3 of the escalator/travelator 1. Evident furthermore is a pallet belt 5′ including pallets 4′ of a travelator as suggested. Each pallet 4′ is equipped with a pulley 9′ connected to each pallet 4′ by a pin 15. Here too, in this arrangement, the first and second lower detectors 7, 7′ are provided in the vicinity of the respective return portions 2, 3 of the pallets 4′ and directed level with the pin 15 representing a characteristic, consistently repetitive feature.

The analyzer/controller electronics 11 incorporate two microprocessors 16, 17 connected to the first and second lower detectors 7, 7′. The microprocessors 16, 17 are interconnected by data lines 18 to ensure mutual monitoring, so that the microprocessors 16, 17 not only keep a check on local disturbances but also check that the detector pulses supplied to each microprocessor 16, 17 are within a tolerance range. The reference numerals 19, 20 respectively identify the power supply of a so-called safety chain (circuit) and the power supply of the analyzer/controller electronics 11.

As soon as trouble is sensed in the region of one of the detectors 7, 7′, the contacts 21, 22 of a safety relay (not shown) are activated by the microprocessors 16, 17 resulting in the escalator drive (not shown) being instantly halted. Provided outside of the analyzer/controller electronics 11 are further contacts 23, 24, 25 of further safety elements 26, 27, 28 which may be, e.g., emergency OFF contacts or the like.

In embodiments where wireless communication between the detectors 7, 7′, 7″, 7′″ and the microprocessors 16, 17, 36, 37 or analyzer/controller electronics 11 is provided, the signals can be simply forwarded to the wanted components in the analyzer/controller electronics 11 of the device for monitoring the steps 4 (pallets 4′) of the escalator/travelator 1.

Should the first or second detector 7, 7′ develop a fault or the inter-exchanged starter signals of microprocessors 16, 17 fail to agree, an AUTO power OFF of the escalator/travelator 1 is triggered. When one of the detectors 7, 7′ “sees” that the characteristic feature such as, for example, the pin 15 of a pallet 4′ no longer occurs within the pre-programmed time interval, this is communicated via the signal leads 29, 30 to each microprocessor 16, 17, resulting in the drive being powered OFF.

Normal operation of the escalator/travelator 1 produces a sequence of pulses (signals) in which case the analyzer/controller electronics 11 also monitors any damage to the detectors 7, 7′ or leads 29, 30. These signals alternate between 0 and 1. Should one of the signals be a constant 0 or 1 this is seen as a fault in the region of a detector 7, 7′ or a lead 29, 30, prompting a power OFF.

In the same way, as already described above with reference to the lower first and second detectors 7, 7′, a redundancy check is performed between the microprocessors 36, 37 of the upper first and second detectors 7″, 7′″, the switches formed by all microprocessors 16, 17, 36, 37 being circuited in series in the safety circuit.

It is understood that all comments as to the embodiments as shown in FIGS. 1 to 3 mainly relating to an escalator apply just the same for travelators. Furthermore, the arrangement and circuiting of the detectors with the safety device is just as relevant as in the example embodiment. Other features of the example embodiment such as, e.g., how the detectors are mounted and directed, are not mandatory.

What is claimed is:

1. In an escalator or travelator configured to travel in two directions and comprising a step or pallet belt returned in first and second return portions facing away from each other, a monitoring device for detecting steps or pallets of the step or pallet belt, the device comprising:
a first detector configured to detect the steps or pallets in one of the directions of travel;
a second detector configured to detect the steps or pallets in the other direction of travel; and
an electronic analyzer/controller functionally coupled with each of the first and second detectors, wherein the electronic analyzer/controller is configured to receive and compare signals from the first and second detectors for the two directions of travel and derive therefrom a signal for halting the escalator or travelator, whereby when the signals from at least one of the first and second detectors indicates a missing step or pallet within the step or pallet belt, the electronic analyzer/controller outputs the derived signal to halt a drive of the escalator or travelator.

2. The device as set forth in claim 1, wherein a spacing of the first detector from the first return portion or from a first comb plate is less than from the second return portion or a second comb plate, and wherein a spacing of the second detector from the second return portion or from the second comb plate is less than from the first return portion or from the first comb plate.

3. The device as set forth in claim 1, wherein the first and second detectors are simultaneously operable independent of the direction of travel of the escalator or travelator.

4. The device as set forth in claim 1, wherein the first detector is arranged proximate the first return portion, and wherein the second detector is arranged proximate the second return portion.

5. The device as set forth in claim 4, wherein the first detector is spaced away from the first return portion and the second detector is equally spaced away from the second return portion.

6. The device as set forth in claim 1, further comprising first and second upper detectors arranged in a region of an exposed upper run of the escalator or travelator.

7. The device as set forth in claim 1, further comprising first and second lower detectors arranged in a region of a return run of the escalator or travelator.

8. The device as set forth in claim 1, wherein the electronic analyzer/controller comprises a first microprocessor coupled to the first detector and a second microprocessor coupled to the second detector, the first and second microprocessors each configured to operate independent of the other and to monitor each other.

9. The device as set forth in claim 8, wherein the first and second microprocessors are coupled to safety contacts configured to instantly halt the escalator or travelator.

10. The device as set forth in claim 1, wherein the first and second detectors are proximity or contactless sensors.

11. The device as set forth in claim 1, wherein each of the first and second detectors include detectors arranged at different levels to sense diverse portions of each step or pallet.

12. The device as set forth in claim 1, wherein the first and second detectors are directed at a pin of a step or pallet pulley provided outside of each drive train.

13. The device as set forth in claim 8, wherein the first and second microprocessors are configured to exchange, within given time intervals, status messages corresponding to an operating status of the first and second detectors and corresponding to a status of the first and second microprocessors.

14. The device as set forth in claim 1, wherein at least one of the first and second detectors is configured for wireless communication with the electronic analyzer/controller.

15. The device as set forth in claim 1, wherein the electronic analyzer/controller is configured for wireless communication with another component of the escalator or travelator.

16. The device as set forth in claim 15, wherein the other component comprises at least one of a main controller of the escalator or travelator, the first detector, the second detector, or a contact of a further safety element.

17. The device as set forth in claim 1, wherein the electronic analyzer/controller is connected by a serial bus to another component of the escalator or travelator.

18. The device as set forth in claim 17, wherein the other component comprises at least one of a main controller of the escalator or travelator, the first detector, the second detector, or a contact of a further safety element.

19. The device as set forth in claim 1, further comprising at least one speed detector configured to monitor a speed of a handrail or drive motor of the escalator or travelator, wherein the speed detector is functionally connected to the electronic analyzer/controller.

20. In an escalator or travelator configured to travel in two directions and comprising a step or pallet belt returned in first and second return portions facing away from each other, a method for monitoring the presence of steps or pallets of the step or pallet belt using a device having a first detector configured to detect the steps or pallets in one of the directions of travel, a second detector configured to detect the steps or pallets in the other direction of travel, and an electronic analyzer/controller functionally coupled with each of the first and second detectors, the method comprising:
receiving signals from the first and second detectors corresponding to the steps or pallets;
comparing the signals from the first and second detectors;
outputting a signal to a drive of the escalator or travelator to halt the escalator or travelator when the comparison indicates a missing step or pallet within the step or pallet belt.

21. The method as set forth in claim 20, wherein the received signals from the first and second detectors comprise at least one characteristic and periodically recurring features of the steps or pallets.

22. The method as set forth in claim 21, wherein the escalator or travelator is halted when the comparison indicates a lack of at least one of the characteristic and periodically recurring features.

23. The method as set forth in claim 20, further comprising, irrespective of the direction of travel of the escalator or travelator, analyzing the signals of the first and second detectors for both directions of travel.

24. The method as set forth in claim 20, further comprising wirelessly communicating with another component of the escalator or travelator.

25. The method as set forth in claim 24, wherein the other component comprises at least one of a main controller of the escalator or travelator, the first detector, the second detector, or a contact of a further safety element.

26. The method as set forth in claim 20, further comprising communicating via a serial bus with another component of the escalator or travelator.

27. The method as set forth in claim 26, wherein the other component comprises at least one of a main controller of the escalator or travelator, the first detector, the second detector, or a contact of a further safety element.

28. The method as set forth in claim 20, wherein the comparing comprises comparing the signals in mutually monitoring processors.

29. The method as set forth in claim 20, wherein the receiving includes receiving the signals wirelessly from the first and second detectors.

30. An escalator or travelator configured to travel in two directions and comprising:
a step or pallet belt returned in first and second return portions facing away from each other and including a plurality of steps or pallets; and
the monitoring device as set forth in claim 1.
